(19) United States
(12) Patent Application Publication
(10) Pub. No.: US 2008/0041675 A1
(43) Pub. Date: Feb. 21, 2008

(54) Brake Disk, In Particlular for a Vehicle

(75) Inventors: Johann Baumgartner, Moosburg (DE); Wolfgang Pahle, Bad Wiessee (DE); Johann Iraschko, Schweitenkirchen (DE)

Correspondence Address: CROWELL & MORING LLP;INTELLECTUAL PROPERTY GROUP, P.O. BOX 14300, WASHINGTON, DC, 20044-4300, US

(73) Assignee: KNORR-BREMSE SYSTEM FUER, Muenchen (DE)

(21) Appl. No.: 11/847,644

(22) Filed: Aug. 30, 2007

Related U.S. Application Data
(63) Continuation of application No. PCT/EP06/01829, filed on Feb. 28, 2006.

(30) Foreign Application Priority Data
Mar. 3, 2005 (DE) 10 2005 009 744.8

(51) Int. Cl. F16D 65/12

(52) U.S. Cl. 188/218 XL; 29/428

(57) ABSTRACT

A brake disc for a vehicle has at least one annular friction surface provided on at least one outer face of the disc to which a brake pad can be applied for braking purposes. The friction surface has a large number of subsegments, at least some of which are physically separated from one another by expansion joints. The brake disc is configured in such a way that the depth of the expansion joints is greater than the permissible rate of wear of the friction surface.

This application is a continuation of international application PCT/EP2006/001829, filed Feb. 28, 2006, the entire disclosure of which is incorporated herein by reference and which, in turn, claims priority of German patent application 10 2005 009 744.8, filed Mar. 3, 2005.

### BACKGROUND AND SUMMARY OF THE INVENTION

The present invention relates to a brake disk for a vehicle having at least one annular friction surface, provided on at least one outer side, against which a brake pad can be pressed for braking purposes, and in which the friction surface consists of a multiplicity of subsegments that are at least partially physically separated from one another by expansion joints.

Brake disks find use in many fields of application. When used in commercial vehicles, the brake disks are subjected to particularly high loads.

Frictional pressing against the brake pads, which usually act bilaterally upon the brake disk, generates frictional heat, which leads to a rise in temperatures in the brake pads and in the brake disk.

Since the frictional heat is generated on the brake surface, in the direction of the middle of the brake disk, a temperature gradient is obtained. This gradient is particularly pronounced in internally ventilated brake disks. Here, the faster the heat is generated on the brake surface, the greater the temperature gradient becomes.

Temperature differences can also be obtained directly in the brake surface. The cause of these differences is the inhomogeneous contact between the friction surfaces of the contacting brake pad and the brake disk. Higher temperatures are generated at sites with high surface pressure than at sites with lower surface pressure. The sites of different temperatures can be situated very close together.

These different temperatures produce high mechanical stresses in the brake disk, which are induced by different temperature-conditioned material expansions. This can give rise to crack formations in the brake surface, which, in the event of frequent high thermal load, can lead in extreme cases to tearing of the brake disk.

Since a temperature increase in braking occurs very rapidly, no homogeneous heat distribution can materialize. This is the case in directions both transverse and longitudinal to the brake surface. In part, plastic deformations arise in the brake surface as a result of the locally occurring high temperature. When the brake disk cools, the material shrinks. The previously plastically deformed sites are now acted upon by high tensile stresses produced by the surrounding, non-plastically deformed sites on the brake surface. These tensile stresses can be greater than the tensile strength of the material, which then leads to cracking problems, particularly when the brake disks, as is common, are made of cast iron.

In order to achieve cooling, it is known from German document DE 23 08 256 A to provide the friction surface with grooves by which a closed wet water film is prevented from forming.

However, these grooves have small depths, which, though they are sufficient to interrupt a water film and, because of a formed larger surface area, produce a certain improvement in heat removal, do not function in the sense of expansion joints, by which the different thermal expansion behavior of the subsegments could be equalized.

In this sense, a brake disk known from German document DE 195 12 934 A1 also deserves attention. In this disk, grooves are likewise provided and serve for cooling and interruption of a water film.

It is here presented as an advantage that the depth of the grooves corresponds to the thickness of the friction surface, so that, following wearing of this friction surface, the grooves are no longer recognizable as such and the brake disk has to be fully replaced.

One drawback with the known brake disks is that the expansion of the subsegments subjected to frictional heat extends into the core region of the brake disk, i.e. into a region beyond the maximally usable thickness of the friction surface.

This can give rise to the material deformations described, resulting in cracking.

One object of the present invention is therefore to refine a brake disk such that its service life is substantially improved with minor effort in design terms.

This object is achieved by way of a brake disk in which depths of expansion joints exceed a permissible degree of wear of the friction surface.

As a result of this design, each subsegment can expand parallel to the brake surface in all directions without hindrance, not only within the depth which is determined by the permissible degree of wear of the friction surface, but beyond this into the core region. The described plastic deformations are thereby prevented. A precondition for this, however, is that the subsegments are respectively dimensioned suitably small.

According to an advantageous feature of the invention, the subsegments, in cross section, are kept slender, i.e. the cross-sectional areas are relatively narrow while the height is relatively large. Consequently, a very large section modulus is obtained, so that flexural loads upon the brake disk have only a minor impact. Heat cracks which might possibly be formed in the friction surfaces of the subsegments are therefore not further enlarged by high mechanical stresses. In addition, the growth in cracks is limited by the cross-sectional contour of the respective subsegment. A heat crack formed in the subsegment cannot spread beyond the contour thereof.

Advantageously, the expansion joints and thus the subsegments for attaining a uniform wear behavior of brake disk and brake pads are designed such that, on any chosen circumferential lines of the brake disk, the same ratios of expansion joint width to subsegment width are found.

A systematic non-uniform wearing of the brake disk, conditioned, for example, by geometry and material properties of the brake pad, can be counteracted by a corresponding partial change in ratios of expansion joint width to subsegment width. An enlargement of the expansion joint leads to a reduction in subsegment width, which leads to an increase in brake disk wear. Correspondingly, if the subsegment width is enlarged, the brake disk wear is reduced.

Besides minimization of the risk of heat cracks, a more favorable temperature behavior is also achieved by the invention. The brake surface, by virtue of the walls of the expansion joints, has a larger surface area, by which, due to convection, heat is released directly to the environment.

According to a preferred refinement of the invention, the depth of the expansion joints amounts to 1.5 to 2 times the permissible degree of wear. Given a depth of wear of, for example, 4 mm, the depth of the expansion joints is consequently about 6-8 mm.

Since, as a result of the design improvement of the brake disk, the risk of cracking is, in principle, minimized, the requirements placed upon the thermal conductivity and thermal strength of the brake disk material are likewise reduced, and a greater selection of usable materials is obtained.

In terms of brake pad development, the invention also constitutes a fundamental improvement, since less regard now has to be paid to the tearing behavior of the brake disk. This includes the choice of pad qualities, since these are more broadly compatible with the new brake disk.

The manufacture of the new brake disk can be realized at least cost-neutrally in relation to the known brake disk, since merely an appropriate design of the casting pattern is necessary, in which case mechanical machining can be dispensed with.

The outline form of the subsegments, and thus the course and arrangement of the expansion joints, can be different. The subsegments can thus be configured in the style of knobs such that they are distributed in concentric circles. The outline contour of each subsegment can be round, trapezoidal, diamond-shaped, or polygonal, or can take some other geometric form. The shaping of the subsegments can be determined by an optimization of the cooling efficiency or by an optimization of the manufacturing method. It is also conceivable to combine different outline forms of the subsegments on either side of the brake disk.

The brake disk according to the invention can be made, in all standard embodiments, as a so-called neck or cup disk, as a composite casting brake disk, and as a flat brake disk.

In the latter construction, it is particularly appropriate to manufacture the casting blank by the so-called stack casting method. Here, at least two, and preferably more, brake disks are made lying one above the other. Respectively lying between the brake disks is a separating plate made of molded material, which also contains the expansion joint profiling in the friction surface. A plurality of brake disks are here manufactured in a single casting operation, stacked one above the other in a column.

Through suitable design and material choices of the molded material separating plates, a faster cooling of the outer subsegments relative to the brake disk core can be achieved. Hence, the material properties of the friction surfaces, on the one hand, and of the brake disk core, on the other hand, can be optimized in a particularly load-conforming manner. The brake disk core remains ductile and maintains a high toughness for the fulfillment of the set mechanical requirements. The friction surfaces of the subsegments, on the other hand, become hard and particularly wear-resistant, without detriment to the mechanical load-bearing capacity.

The invention offers major advantages, especially where the brake disk consists of a ceramic material which naturally possesses a relatively poor thermal conductivity, in which case internal ventilation can only be realized with a considerable production effort that is unacceptable for a mass-produced product.

Further advantageous embodiments of the invention are also claimed.

Illustrative embodiments of the invention are described below with reference to the appended drawings.

### BRIEF DESCRIPTION OF THE DRAWINGS

FIGS. 1, 3, 4, and 5 show respective illustrative embodiments of a brake disk according to the invention in top views, and

FIG. 2 shows details of a part of the brake disk according to FIG. 1 in a cross-sectional representation.

### DETAILED DESCRIPTION OF THE INVENTION

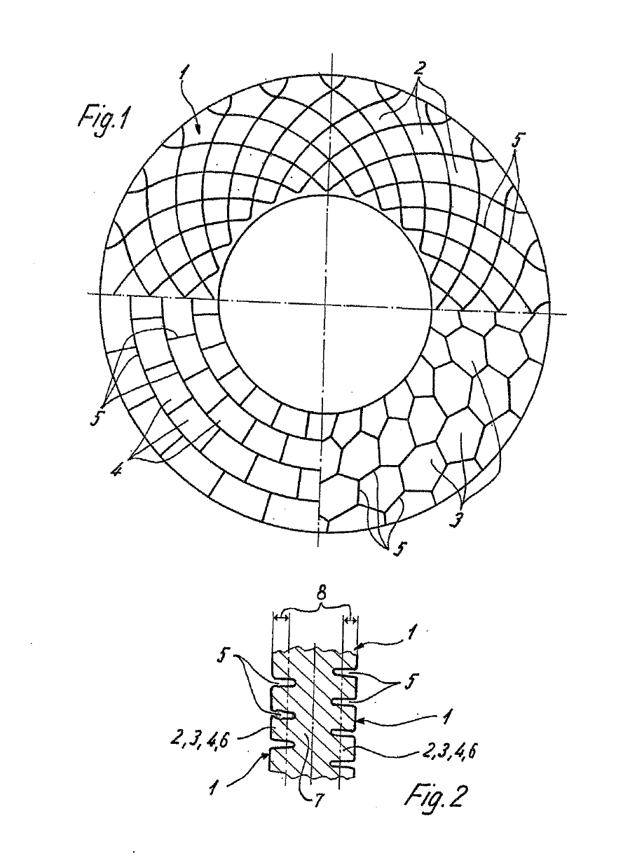

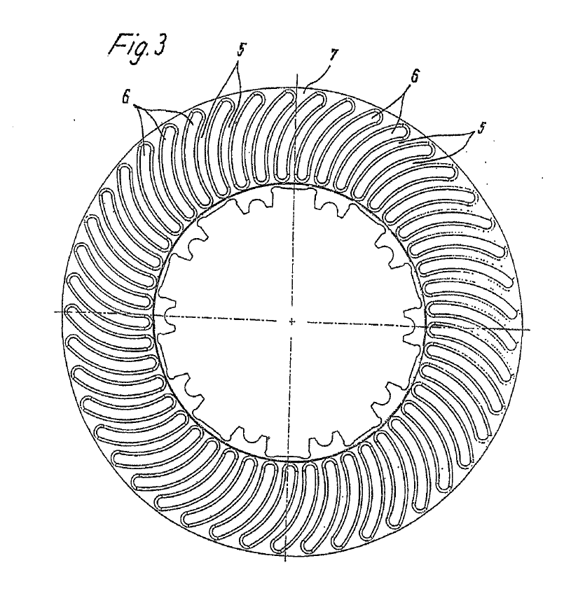

In FIGS. 1, 3, 4, and 5, brake disks for vehicles are respectively represented. Each disk has, on its sides, annular friction surfaces 1 (FIG. 2), against which, for braking, a brake pad (not represented) can be pressed.

In the present illustrative embodiments, the two friction surfaces 1 are joined together by a continuous brake disk core 7, so that the brake disk is in one piece. In principle, the possibility also exists of providing the brake disk with two thermally separated friction surfaces 1, in which case the internally ventilated brake disk is provided with cooling ducts between the two friction surfaces 1.

The friction surface 1 has a multiplicity of at least partially physically separated subsegments 2, 3, 4, and 5, which, as illustrated by FIGS. 1, 3, 4, and 5, can differ in terms of contouring.

The upper half of the brake disk shown in FIG. 1 shows subsegments 2, which have, in the broadest sense, a rhombic contour and are respectively separated by expansion joints 5.

In FIG. 1, in the left-hand lower quadrant, subsegments 4 are of tile-shaped configuration in outline, while subsegments 3 in the right-hand lower quadrant are of honeycomb design.

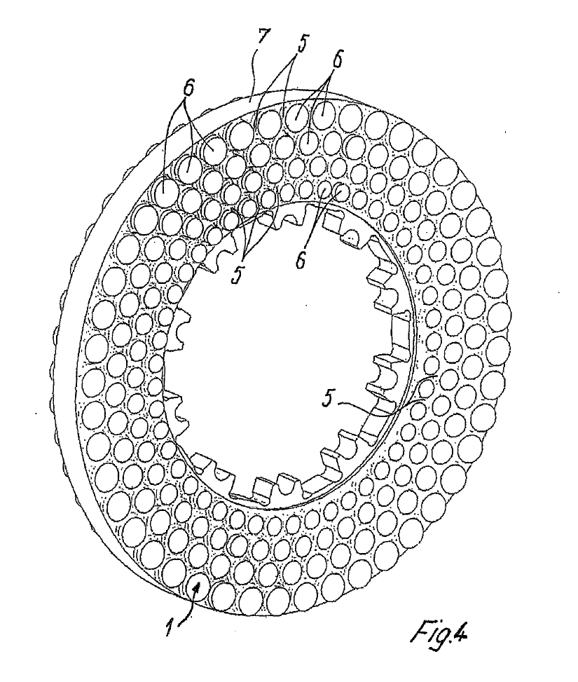

In the illustrative embodiment according to FIG. 3, the expansion joints 5, just like the subsegments 6, run in an even distribution approximately radially and in a sickle shape, all the subsegments 6 being identical in shape and dimension, as are all the expansion joints 5.

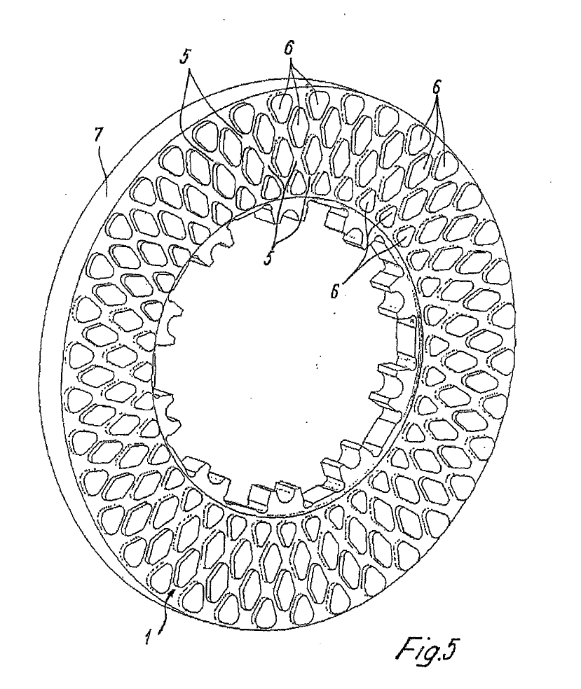

In the example shown in FIG. 4, the subsegments 6 are round in outline and of knob-like configuration. The expansion joints 5 are here formed by the spacings between the individual part segments 6.

These knob-like subsegments 5 are disposed in a plurality of concentric circles. The subsegments 5 respectively of a circle are the same from outside to inside, but become smaller in terms of their diameter.

In FIG. 5, the subsegments 6 are of partly triangular and partly diamond-shaped design in terms of their outline, yet are always spaced apart, the spacings defining the expansion joints 5.

In place of the outlines which are shown here and which should be viewed only as examples, other outline forms of the subsegments are also conceivable; for example, elliptical or polygonal forms are useable. In any event, the stud-like protruding subsegments form in their entirety a more or less planar friction surface.

As is shown by FIG. 2, the expansion joints 5, which laterally delimit the subsegments 2, 3, 4, and 6, are inserted on both sides sufficiently far into the brake disk that, in the middle region, there remains a circumferentially continuous core 7.

According to the invention, the depth of the expansion joints 5 is greater than the permissible degree of wear of the friction surface 1; this degree of wear is indicated by the reference number 8.

Preferably, the depth of the expansion joints 5 amounts to approximately 1.5 to 2 times the degree of wear 8.

The width of the expansion joints 5 is dimensioned such that sufficient ventilation for the cooling of the subsegments 2, 3, 4, and 6 is ensured.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

We claim:

1. A brake disk for a vehicle, comprising at least one annular friction surface, provided on at least one outer side, against which a brake pad can be pressed for braking purposes, wherein the friction surface consists of a multiplicity of subsegments that are at least partially physically separated from one another by expansion joints, and wherein the depths of the expansion joints exceed a permissible degree of wear of the friction surface.

2. The brake disk as claimed in claim 1, wherein the depths of the expansion joints amount to approximately 1.5 to 2 times the permissible degree of wear of the friction surface.

3. The brake disk as claimed in claim 1, wherein the at least one annular friction surface is one of at least two bilateral friction surfaces between which there is configured a continuous brake disk core.

4. The brake disk as claimed in claim 1, wherein the subsegments are of slender configuration in cross section.

5. The brake disk as claimed in claim 1, wherein the subsegments have approximately diamond-shaped outline configurations.

6. The brake disk as claimed in claim 1, wherein the subsegments have approximately honeycomb outlined configurations.

7. The brake disk as claimed in claim 1, wherein the subsegments have tile-like configurations.

8. The brake disk as claimed in claim 1, wherein the subsegments are configured to be level and mutually aligned in terms of height.

9. The brake disk as claimed in claim 1, wherein the expansion joints have widths dimensioned such that sufficient ventilation is provided.

10. The brake disk as claimed in claim 1, wherein, with a bilateral arrangement of subsegments, the expansion joints have depths dimensioned such that they end at a distance apart from opposing expansion joints.

11. The brake disk as claimed in claim 1, wherein the disk consists of a cast material such as cast iron.

12. The brake disk as claimed in claim 1, wherein the subsegments have stud-like configurations.

13. The brake disk as claimed in claim 1, wherein the subsegments and adjacent expansion joints are respectively configured shapes of sickles such that they extend approximately radially.

14. The brake disk as claimed in claim 1, wherein all the subsegments and all the expansion joints, respectively, are the same in terms of contour and dimension.

15. The brake disk as claimed in claim 1, wherein the subsegments have cylindrical configurations.

16. The brake disk as claimed in claim 15, wherein the cylindrical subsegments are disposed in concentric circles.

17. The brake disk as claimed in claim 16, wherein the cylindrical subsegments of each concentric circle are equal in size in terms of their diameters.

18. The brake disk as claimed in claim 16, wherein the cylindrical subsegments of each concentric circle are different than those of an adjoining concentric circle and decrease in size from outside to inside.

19. The brake disk as claimed in claim 1, wherein the subsegments have elliptical, triangular, or polygonal outlines.

20. The brake disk as claimed in claim 1, wherein ratios of ventilation duct width to subsegment width are the same on any chosen circumferential line of the brake disk.

21. The brake disk as claimed in claim 1, wherein the brake disk is configured as a neck or cup disk, as a composite casting brake disk, or as a flat brake disk.

22. A process for manufacturing a brake disk as claimed in claim 1, comprising stack casting a casting blank with at least two brake disks made lying one above the other.

23. The process as claimed in claim 22, further comprising situating a separating plate, made of a molded material and having subsegment profiling and expansion joint profiling, respectively, of the friction surface of the brake disks, between the brake disks.
